(19) United States
(12) Patent Application Publication
(10) Pub. No.: US 2020/0280709 A1
(43) Pub. Date: Sep. 3, 2020

(54) Three Dimensional Rapid Imaging System and Method

(71) Applicant: Shui Yin Lo, Arcaida, CA (US)

(72) Inventor: Shui Yin Lo, Arcaida, CA (US)

(21) Appl. No.: 16/702,252

(22) Filed: Dec. 3, 2019

Related U.S. Application Data
(60) Provisional application No. 62/775,489, filed on Dec. 5, 2018.

(51) Int. Cl. H04N 13/122; H04N 5/33

(52) U.S. Cl. CPC H04N 13/122; H04N 5/332

(57) ABSTRACT

A three dimensional rapid imaging system and method captures multiple thermal and optical images while rotating around a patient, and from different positions and angles, and then overlays the thermal images over the optical images to produce a 3D image having enhanced thermal features. The system provides a rod that follows a circular pathway that encircles a patient. A motor propels the rod along the circular pathway. The infrared image capturing devices and optical image capturing devices are in a spaced-apart relationship along the length of the rod. The image capturing devices can each have different positions and angles along the rod. A first processor controls the angular velocity of the rod while moving along the circular pathway. The first processor also controls the position of each image capturing device. A second processor manipulates the images to overlay the optical images with thermal images; thereby producing enhanced 3D images.

### CROSS-REFERENCE TO RELATED APPLICATIONS

This application claims priority to, and is a regular patent application of, Provisional U.S. Pat. No. 62/775,489, filed on Dec. 5, 2018, which are hereby incorporated by reference in their entirety.

### FIELD OF THE INVENTION

The present invention relates generally to a three dimensional rapid imaging system and method that captures multiple images from different image capturing devices while moving in a circular pathway. More so, an imaging system provides a rod that follows a circular pathway to rotate around a patient; whereby a plurality of infrared image capturing devices are disposed in a spaced-apart relationship along the length of the rod, and capturing thermal images while rotating, and from at least one position and at least one angle; whereby a plurality of optical image capturing devices are disposed in a spaced-apart relationship along the length of the rod, and capturing optical images while rotating, and from at least one position and at least one angle; whereby a first processor controls the angular velocity of the rod and the position an dangle of the image capturing devices; and whereby a second processor manipulates the images, such that the optical images overlay the thermal images to produce an enhanced three-dimensional image of the patient.

### BRIEF DESCRIPTION OF THE DRAWINGS

The invention will now be described, by way of example, with reference to the accompanying drawings, in which:

FIG. 1 illustrates a perspective view of an exemplary three dimensional rapid imaging system, in accordance with an embodiment of the present invention;

FIG. 2 illustrates a perspective view of an exemplary rod carrying a plurality of thermal and optical image capturing devices, in accordance with an embodiment of the present invention;

FIG. 3 illustrates a top view of an exemplary cylindrical structure, in accordance with an embodiment of the present invention;

FIGS. 4A, 4B, 4C, and 4D illustrate thermal images of a patient, where FIG. 4A is captured at the 0°, FIG. 4B is captured at 90°, FIG. 4C is captured at 180°, and FIG. 4D is captured at 270°, in accordance with an embodiment of the present invention; and

FIG. 5 illustrates a flowchart diagram of an exemplary method for producing enhanced three dimensional thermal images, in accordance with an embodiment of the present invention.

Like reference numerals refer to like parts throughout the various views of the drawings.

### DETAILED DESCRIPTION OF THE INVENTION

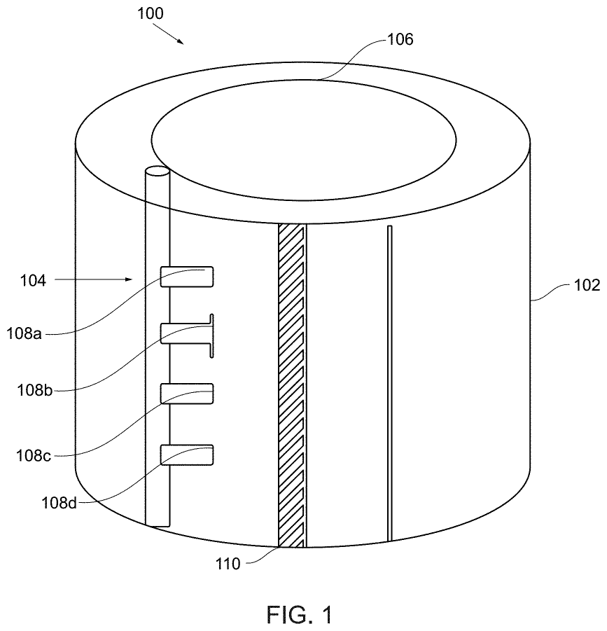

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-5, a three dimensional rapid imaging system 100 and method 200 captures multiple thermal and optical images while rotating around a patient, and from different positions and angles. The system 100 and method 200 then overlays the thermal images over the optical images to produce an enhanced three dimensional image that shows both the temperature and the contour features of different regions of the patient's body.

The system 100 and method 200 provides a cylindrical structure 102 in which the patient enters. It is in the cylindrical structure 102 that the images are captured. The cylindrical structure 102 is defined by a perimeter region having a generally circular pathway 106. A vertically disposed rod 104 is configured to follow the circular pathway 106. A motor propels the rod 104 along the circular pathway 106, which may include an upper and lower track followed by the rod 104. The rod rotates at a predetermined angular velocity around the patient.

A plurality of infrared image capturing devices 108a, 108b, 108c, 108d and a plurality of optical image capturing devices 112a, 112b, 112c, 112d are disposed in a spaced-apart relationship along the length of the rod 104. The image capturing devices 108a-d, 112a-d may each be manipulated to at least one position along the length of the rod 104, and at least one angle in relation to the rod 104.

In one embodiment, a first position of the image capturing devices captures approximately the head of the patient. A second position captures approximately the breast of the patient. A third position captures approximately the abdomen of the patient. A fourth position captures the feet of the patient. The position of the image capturing devices can be manipulated to derive a desired enhanced thermal image.

The image capturing devices is also configured to orient at different angles along the length of the rod 104. The angles of the image capturing devices can range from 0° to 360° angle of the image capturing device. The angles of the image capturing devices can be manipulated to derive a desired enhanced thermal image.

A first processor 114 controls the angular velocity of the rod 104 as it moves along the circular pathway 106. The first processor 114 also controls the position, i.e., height of the image capturing devices 108a-d, 112a-d. The first processor 114 also controls the angle for each image capturing device 108a-d, 112a-d.

A second processor 116 manipulates the images, such that the optical images overlay the thermal images to produce an enhanced three dimensional image of the patient. The three dimensional image is an enhanced thermal image that shows both the temperature and the contours, smaller features of the patient.

In one aspect, a three dimensional rapid imaging system 100, comprising:
a generally circular pathway 106;
a rod 104 configured to operatively attach to the circular pathway 106, the rod 104 disposed in a generally vertical orientation;
a motor configured to propel the rod 104 along the circular pathway 106;
a plurality of infrared image capturing devices 108a, 108b, 108c, 108d disposed along the rod 104, the plurality of infrared image capturing devices 108a, 108b, 108c, 108d arranged in a stacked, spaced-apart configuration along the length of the rod 104, each infrared image capturing device 108a, 108b, 108c, 108d configured to capture the thermal image from at least one position and at least one angle;
a plurality of optical image capturing devices 112a, 112b, 112c, 112d disposed along the rod 104, the plurality of optical image capturing devices 112a, 112b, 112c, 112d arranged in a stacked, spaced-apart configuration along the length of the rod 104, each optical image capturing device 112a, 112b, 112c, 112d configured to capture the optical image from the at least one position and the at least one angle;
a first processor 114 configured to control the angular velocity of the rod 104 along the circular pathway 106, the first processor 114 further configured to control the at least one position and the at least one angle of the plurality of infrared image capturing devices 108a, 108b, 108c, 108d, the first processor 114 further configured to control the at least one position and the at least one angle of the plurality of optical image capturing devices 112a, 112b, 112c, 112d; and
a second processor 116 configured to manipulate the captured thermal image and the captured optical image, whereby the thermal image at least partially overlays the optical image to form an enhanced thermal image.

In another aspect, the system 100 comprises a cylindrical structure 102.

In another aspect, the circular pathway 106 is disposed inside the cylindrical structure 102.

In another aspect, the cylindrical structure 102 has a height of about 2.5 meters.

In another aspect, the cylindrical structure 102 has a door 110.

In another aspect, the circular pathway 106 has a radius between 1 to 2 meters.

In another aspect, the circular pathway 106 is a lower track and an upper track.

In another aspect, the extremes of the rod 104 join with the lower and upper tracks.

In another aspect, the plurality of infrared image capturing devices 108a, 108b, 108c, 108d comprises four infrared image capturing devices 108a, 108b, 108c, 108d.

In another aspect, the plurality of optical image capturing devices 112a, 112b, 112c, 112d comprises four optical image capturing devices 112a, 112b, 112c, 112d.

In another aspect, the system 100 further comprises a plurality of optical stereo image capturing devices.

In another aspect, the at least one position includes at least one member selected from the group consisting of: a first position of the head, a second position of the breast, a third position of the abdomen, and a fourth position of the feet.

In another aspect, the at least one angle includes at least one member selected from the group consisting of: 45°, 90°, 135°, 180°, 225°, 270°, 315°, and 360°.

In another aspect, a method 200 for producing enhanced thermal images, comprises:
entering a cylindrical structure 102 encompassed by a circular pathway 106;
providing a rod 104 configured to operatively attach to the circular pathway 106, the rod 104 disposed in a generally vertical orientation;
propelling the rod 104 along the circular pathway 106;
capturing a thermal image with a plurality of infrared image capturing device, the plurality of infrared image capturing devices 108a, 108b, 108c, 108d arranged in a stacked, spaced-apart configuration along the length of the rod 104, each infrared image capturing device 108a, 108b, 108c, 108d configured to capture the thermal image from at least one position and at least one angle;
capturing an optical image with a plurality of optical image capturing device, the plurality of optical image capturing devices 112a, 112b, 112c, 112d arranged in a stacked, spaced-apart configuration along the length of the rod 104, each optical image capturing device 112a, 112b, 112c, 112d configured to capture the optical image from at least one position and at least one angle;
controlling the angular velocity of the rod 104 along the circular pathway 106 with a first processor 114;
controlling the at least one position and the at least one angle of the plurality of infrared image capturing devices 108a, 108b, 108c, 108d and the plurality of optical image capturing devices 112a, 112b, 112c, 112d with a first processor 114; and
manipulating the captured thermal image and the captured optical image with a second processor 116, whereby the thermal image at least partially overlays the optical image to form an enhanced thermal image.

One objective of the present invention is to provide an enhanced thermal image of a patient that shows the temperatures and the finer contours of the patient.

Another objective is to enable multiple infrared and optical image capturing devices 112a, 112b, 112c, 112d to work together.

Another objective is to adjust the position or the angle of the image capturing devices while they are rotating.

Another objective is to merge thermal images and optical images to produce an enhanced thermal image that shows the smaller features and contours of the human body with temperatures.

Another objective is to provide an easy to use three dimensional image capturing system 100 and method 200.

FIG. 1 references three dimensional rapid imaging system 100 captures multiple thermal and optical images and then digitally merges the captured images to produce an enhanced thermal image that shows the smaller features and contours of the human body with temperatures. The three dimensional rapid imaging system 100, hereafter “system 100”, comprises a cylindrical structure 102 where a patient enters and the images of regions of the patient's body are captured. In some embodiments, the cylindrical structure 102 may have radius between 1 to 2 meter and a height of about 2.5 meters. The cylindrical structure 102 is made of optical and infrared opaque material, which may be either aluminum, stainless steel, or plastic.

The cylinder has a door 110 for the patient to enter and leave. In one embodiment, the patient disrobes before entering the cylindrical structure 102 through the door 110. The patient stands in the middle of the cylindrical structure 102. The door 110 automatically shut after the patient enters. After the door 110 is shut, there is total darkness inside the cylindrical structure 102. This darkness improves the quality of the images.

A generally circular pathway 106 extends along the inner perimeter of the cylindrical structure 102. The circular pathway 106 may include an upper track 118 and a lower track. A rod 104 that is disposed in a generally vertical orientation is connected at each end at the tracks 118. The rod 104 is configured to follow the circular pathway 106 that rotates around the patient. An electric motor propels the rod 104 along the circular pathway 106.

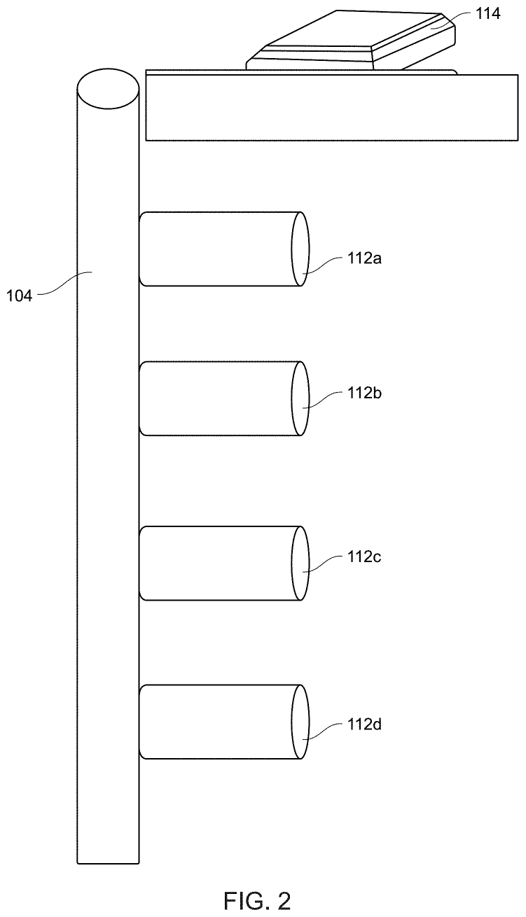

Turning now to FIG. 2, a plurality of infrared image capturing devices 108a, 108b, 108c, 108d and optical image capturing devices 112a, 112b, 112c, 112d are disposed in a spaced-apart relationship along the length of the rod 104. The image capturing devices 108a-d, 112a-d can each have different positions and angles along the rod 104. The infrared and optical image capturing devices 108a-d, 112a-d may be positioned adjacent to each other. In one embodiment, four image capturing devices of each type are used. In yet another embodiment, the system 100 further comprises a plurality of optical stereo image capturing devices (not shown) in place of the optical image capturing devices 112a, 112b, 112c, 112d.

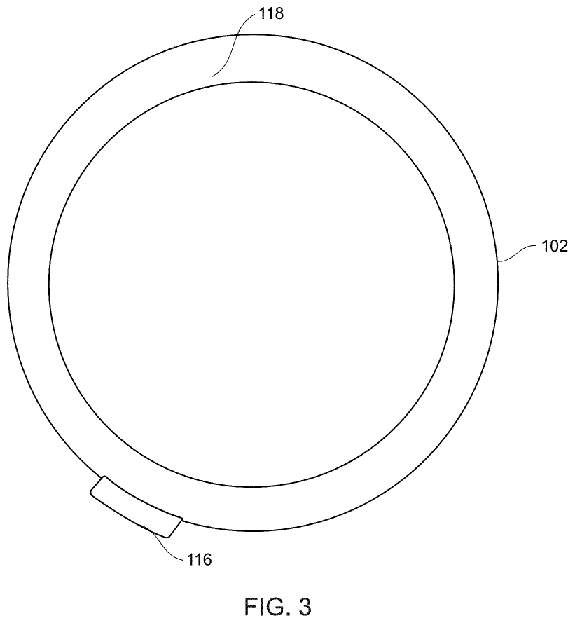

As shown in FIG. 3, a first position of the image capturing devices captures approximately the head of the patient. A second position captures approximately the breast of the patient. A third position captures approximately the abdomen of the patient. A fourth position captures the feet of the patient. Though in other embodiments, the image capturing devices 108a-d, 112a-d may be adjusted along the rod 104 to capture different regions of the body. Or additional image capturing devices may be added to the rod 104. For example, an image of the knee or the top of the skull may be captured.

The image capturing devices 108a-d, 112a-d are also configured to orient at different angles along the length of the rod 104. The angles of the image capturing devices 108a-d, 112a-d can range from 0° to 360°. In some embodiments, the at least one angle includes at least one member selected from the group consisting of: 45°, 90°, 135°, 180°, 225°, 270°, 315°, and 360°. Thus, each camera can capture an image at a different positon, or a different angle, or both. This creates a flexible situation where eclectic images can be captured to produce unique thermal/optical images.

In one embodiment, a first processor 114 controls the angular velocity rod 104 following the circular pathway 106. The first processor 114 also controls the height of each position of the image capturing devices 108a-d, 112a-d. The first processor 114 also controls the angle of each image capturing device 108a-d, 112a-d. In one embodiment, a second processor 116 manipulates the images, such that the optical images overlay the thermal images to produce a three dimensional image of the subject. In one embodiment, a program is written in the second processor 116 to overlay the temperature profile of the body surface on top of either a two dimensional optical picture or a three dimensional optical picture. As a result the image is an enhanced thermal image that shows both the temperature and the contours and smaller features of the patient as a three dimensional image.

In one alternative embodiment, the rod 104 disposed in a generally vertical orientation. One infrared image capturing device 108a is attached to the rod 104, moving vertically along the rod 104 to any position as required by the linear motor to capture the thermal image from at least one position and at least one angle. A linear motor propels the one infrared image capturing device vertically along the rod 104. A first processor 114 is configured to control the velocity of the vertical linear movement of the one infrared image capturing device. The first processor 114 is also configured to control the at least one position and the at least one angle of the one infrared image capturing device 108a.

In one embodiment, wires extend along the rod 104 to connect each to the thermal and optical image capturing devices 112a, 112b, 112c, 112d to the first processor 114. In one embodiment, preliminary analysis of the captured images is analyzed in the first processor 114, and then the result of the preliminary analysis is transmitted by Wi-Fi to the second processor 116 in the main room for further analysis, storage, and print out for the physicians, or other health personals.

It is significant to note that the system 100 and method is also operable without use of an optical image capturing device 112a, 112b, 112c, 112d to capture optical images. In this embodiment, only an infrared image capturing device 108a, 108b, 108c, 108d is used, and the optical image capturing device 112a, 112b, 112c, 112d is absent from the system 100. The second processor 116 is also not necessary, since the process of overlaying the thermal image over an optical image is not utilized. In essence, optical images, whether stereo or not, are not a necessary component at the beginning It is important to realize the variety of rapid imaging without the optical images.

In one alternative embodiment, only one infrared image capturing device moves along the circular pathway as well as linearly. This multiple movement is more economically and saves money. This is because the one infrared image capturing device rotates four times to achieve the same result as four infrared image capturing devices rotating once. Furthermore in some application only a thermograph of the head is needed, so one infrared image capturing device may suffice.

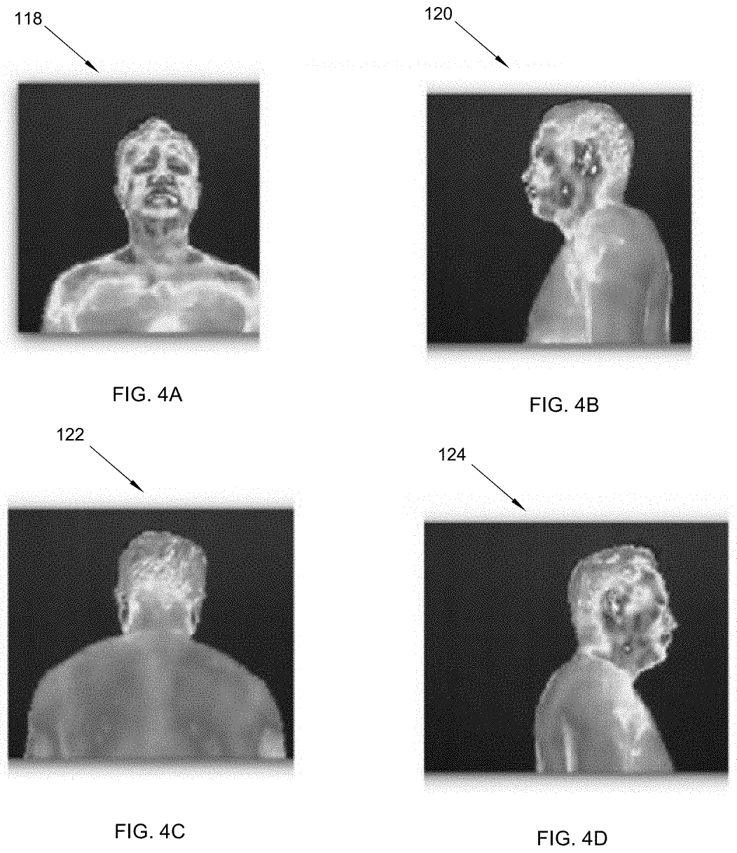

As FIGS. 4A, 4B, 4C, and 4D illustrate, the enhanced thermal images provide a clearer picture of the status of the patient's health. For example, the normal internal temperature of a normal healthy person, as measured from oral insertion of thermometer, is well known to be 37° Celsius independent of outside environmental temperature due to the good insulation of the body.

However, the body skin temperature—as captured by the infrared image capturing devices 108a, 108b, 108c, 108d—for a healthy person is not a constant. If outside temperature is hot like in hot summer time, the skin temperature is hotter, and in cold weather it is cooler. Those skilled in the art will recognize that different people in different weather condition, the healthy skin is 32°+/−1° Celsius, where temperature is T₀. Whether a particular point or region of body surface is hotter or cooler depends on the temperature difference: ΔT=T−T₀

Thus, if the temperature difference is greater than zero, then it is hotter. Such as if ΔT= or >3.0° Celsius, then that part of body, which may be an acupoint, or a meridian, is very inflamed. It is equivalent to the internal oral temperature 40° Celsius. When a green color is used to denote 32° Celsius for normal healthy skin temperature, the part of the body, which may be an acupoint, or a meridian, would be in white color. It is easy, convenient to spot immediately. This is a more effective technique, as numerical number measurement in clinical setting are generally more time consuming.

Inflammation is also indicated in the enhanced thermal images. To make the inflammation area much more observable, a software program is written to show only that part of surface body area that is, ΔT= or >3.0° C.

In term of color, only white body surface is shown. If a segment of meridian is inflamed, the white meridian will be shown vividly alone. The software may show only body surface that is hotter than 2.0° C., where ΔT>2.0° C.

The opposite of the above discussed hot conditions can be observed by the enhanced thermal images as cold. A healthy person will have a warm foot. From infrared imaging, the feet will be shown as green in color. But when a person is sick, or old, or lack of exercise, the feet become cold. The temperature difference is negative, and it is shown in blue. In accordance with the enhanced thermal images, when the feet are colder than 32° Celsius and warmer than 29.5° Celsius, or ΔT<2.5° Celsius, the color of the feet are shown in blue.

As FIGS. 4A, 4B, 4C, and 4D illustrate, the enhanced thermal images provide a clearer picture of the status of the patient's health. Looking at an example of such enhanced three dimensional images, FIG. 4A is captured at the 0° angle 118, FIG. 4B is captured at 90° angle 120, FIG. 4C is captured at 180° angle 122, and FIG. 4D is captured at 270° angle 124.

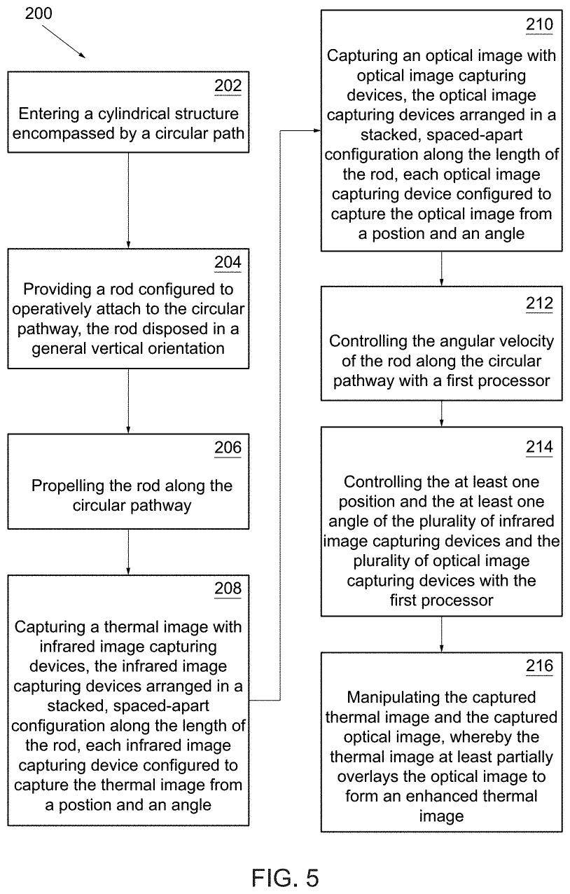

FIG. 5 illustrates a flowchart diagram of an exemplary method 200 for producing enhanced three dimensional thermal images. The method 200 may include an initial Step 202 of entering a cylindrical structure 102 encompassed by a circular pathway 106. The method 200 may further comprise a Step 204 of providing a rod 104 configured to operatively attach to the circular pathway 106, the rod 104 disposed in a generally vertical orientation. A Step 206 includes propelling the rod 104 along the circular pathway 106.

In some embodiments, a Step 208 comprises capturing a thermal image with a plurality of infrared image capturing device, the plurality of infrared image capturing devices 108a, 108b, 108c, 108d arranged in a stacked, spaced-apart configuration along the length of the rod 104, each infrared image capturing device configured to capture the thermal image from at least one position and at least one angle. A Step 210 includes capturing an optical image with a plurality of optical image capturing device, the plurality of optical image capturing devices 112a, 112b, 112c, 112d arranged in a stacked, spaced-apart configuration along the length of the rod 104, each optical image capturing device configured to capture the optical image from at least one position and at least one angle.

In some embodiments, a Step 212 may include controlling the angular velocity of the rod 104 along the circular pathway 106 with a first processor 114. A Step 214 comprises controlling the at least one position and the at least one angle of the plurality of infrared image capturing devices 108a, 108b, 108c, 108d and the plurality of optical image capturing devices 112a, 112b, 112c, 112d with the first processor 114. A final Step 216 includes manipulating the captured thermal image and the captured optical image, whereby the thermal image at least partially overlays the optical image to form an enhanced thermal image.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A three dimensional rapid imaging system, the system comprising:
a generally circular pathway;
a rod configured to operatively attach to the circular pathway, the rod disposed in a generally vertical orientation;
a motor configured to propel the rod along the circular pathway;
a plurality of infrared image capturing devices disposed along the rod, the plurality of infrared image capturing devices arranged in a stacked, spaced-apart configuration along the length of the rod, each infrared image capturing device configured to capture the thermal image from at least one position and at least one angle;
a first processor configured to control the angular velocity of the rod along the circular pathway, the first processor further configured to control the at least one position and the at least one angle of the plurality of infrared image capturing devices, the first processor further configured to control the at least one position and the at least one angle of the plurality of optical image capturing devices;

2. The system of claim 1, further including a plurality of optical image capturing devices disposed along the rod, the plurality of optical image capturing devices arranged in a stacked, spaced-apart configuration along the length of the rod, each optical image capturing device configured to capture the optical image from the at least one position and the at least one angle.

3. The system of claim 1, further including a second processor configured to manipulate the captured thermal image and the captured optical image, whereby the thermal image at least partially overlays the optical image to form an enhanced thermal image.

4. The system of claim 1, further comprising a cylindrical structure.

5. The system of claim 4, wherein the cylindrical structure has a height of about 2.5 meters.

6. The system of claim 5, wherein the cylindrical structure has a door.

7. The system of claim 6, wherein the circular pathway is disposed inside the cylindrical structure.

8. The system of claim 7, wherein the circular pathway has a radius between 1 to 2 meters.

9. The system of claim 8, wherein the circular pathway is a lower track and an upper track.

10. The system of claim 9, wherein extreme ends of the rod join with the lower and upper tracks.

11. The system of claim 1, wherein the plurality of infrared image capturing devices comprises four infrared image capturing devices.

12. The system of claim 1, wherein the system further comprises a plurality of optical stereo image capturing devices.

13. The system of claim 1, wherein the plurality of optical image capturing devices comprises four optical image capturing devices.

14. The system of claim 1, wherein the at least one position includes at least one member selected from the group consisting of: a first position of the head, a second position of the breast, a third position of the abdomen, and a fourth position of the feet.

15. The system of claim 1, wherein the at least one angle includes at least one member selected from the group consisting of: 45°, 90°, 135°, 180°, 225°, 270°, 315°, and 360°.

16. A three dimensional rapid imaging system, the system comprising:
a rod disposed in a generally vertical orientation;
one infrared image capturing device configured to move vertically along the rod to any position as required by the linear motor to capture the thermal image from at least one position and at least one angle;
a linear motor configured to propel the one infrared image capturing device vertically along the rod; and
a first processor configured to control the velocity of the vertical linear movement of the one infrared image capturing device, the first processor further configured to control the at least one position and the at least one angle of the one infrared image capturing device.

17. A method for producing enhanced three dimensional thermal a the method comprising:
entering a cylindrical structure encompassed by a circular pathway;
providing a rod configured to operatively attach to the circular pathway, the rod disposed in a generally vertical orientation;
propelling the rod along the circular pathway;
capturing a thermal image with a plurality of infrared image capturing device, the plurality of infrared image capturing devices arranged in a stacked, spaced-apart configuration along the length of the rod, each infrared image capturing device configured to capture the thermal image from at least one position and at least one angle;
capturing an optical image with a plurality of optical image capturing device, the plurality of optical image capturing devices arranged in a stacked, spaced-apart configuration along the length of the rod, each optical image capturing device configured to capture the optical image from at least one position and at least one angle;
controlling the angular velocity of the rod along the circular pathway with a first processor;
controlling the at least one position and the at least one angle of the plurality of infrared image capturing devices and the plurality of optical image capturing devices with a first processor; and
manipulating the captured thermal image and the captured optical image with a second processor, whereby the thermal image at least partially overlays the optical image to form an enhanced thermal image.
